(19) United States
(12) Patent Application Publication
(10) Pub. No.: US 2018/0293352 A1
(43) Pub. Date: Oct. 11, 2018

(54) System and Method for Decision-Making for Determining Initiation and Type of Treatment for Patients with a Progressive Illness

(71) Applicant: COTA, INC., New York, NY (US)

(72) Inventors: Stuart Goldberg, New York, NY (US); Andrew Pecora, Rumson, NJ (US)

(21) Appl. No.: 15/483,491

(22) Filed: Apr. 10, 2017

(51) Int. Cl. G06F 19/00; G06N 5/02; G06Q 50/22

(52) U.S. Cl. CPC G06F 19/345; G06Q 50/22; G06N 5/025; G06F 19/325

(57) ABSTRACT

A system, non-transitory computer readable medium, and method are provided for determining patient care services for a patient being treated for a life-threatening or life-limiting progressive illness. Patient symptoms are identified by receiving data comprising personal health information of a patient. The level of distress of the patient is determined by analyzing the data comprising personal health information of the patent. A score is established based on criteria comprising the level of distress of the patient and a severity of the patient symptoms. The score correlates the level of distress of the patient with a clinical course of the life-threatening or life-limiting progressive illness. One or more patient care services appropriate for the clinical course of the life-threatening or life-limiting progressive illness and the level of distress of the patient is determined based on the score.

### FIELD OF THE INVENTION

The described invention relates generally to a determination of a treatment path for patients suffering from a life threatening or life-limiting progressive disease, and more particularly to objective, quantitative, and standardized decision making for treatment plans of a patient with serious illnesses.

### BACKGROUND OF THE INVENTION

Palliative care is a specialized type of medical care for a patient with serious progressive illnesses (e.g., a cancer, a lung disease, a heart disease, neurologic disorders, or other chronic progressive diseases such as emphysema) that are typically life-limiting or life-threatening, with a focus on improving the quality of life of the patient rather than focusing on prolongation of life. Palliative care provides treatment of the underlying disease or illness of the patient, but with a focus on providing relief from the symptoms, pain, and stress resulting from the disease. Palliative care treatment can be provided to the patient at any stage of a serious illness. Receipt of palliative care services does not by itself preclude additional treatments designed to prolong life.

Studies have found under-utilization of palliative care services in a timely manner (e.g., more than 30 days prior to death). Delayed or no palliative care treatment typically results in more aggressive medical care and increased cost of healthcare. Starting palliative care treatment earlier in the course of the serious illness can be effective to optimize quality of life parameters, especially at the end of the patient's life.

### SUMMARY

In accordance with one or more embodiments, a patient analysis system is provided for evaluating the distress level of a patient and selecting a clinical course of action for initiating and providing treatment of a patient for a life-threatening or life-limiting progressive illness. The patient analysis system described herein advantageously facilitates objective, quantitative, and standardized decision making for initiating and/or recommending and/or implementing patient care services, including, without limitation, palliative care treatment of the patient. The patient analysis system may also serve as a benchmark tool to assess quality of care among healthcare providers.

In accordance with one or more embodiments, a system, non-transitory computer readable medium, and method are provided for determining patient care services for a patient. According to one such embodiment, determining patient care services for a patient comprises determining whether a patient is eligible for palliative care. Patient symptoms are identified by receiving data comprising personal health information of a patient. A level of distress of the patient is determined by analyzing the data comprising personal health information of the patent. A score is established based on criteria comprising the level of distress of the patient and a severity of the patient symptoms. The score correlates the level of distress of the patient with a clinical course of the life-threatening or life-limiting progressive illness. One or more patient care services appropriate for the clinical course of the life-threatening or life-limiting progressive illness and the level of distress of the patient is determined based on the score for initiating and/or recommending and/or implementing treatment to the patient.

In accordance with one or more embodiments, the data may be data representing the level of distress of the patient, such as, e.g., data covering the domains of performance status, pain, inter-relational data, including, without limitation, a perception of being a burden to loved ones, and depression of the patient. The domains examined may be modified based on the disease, with the goal of being reflective of symptoms and/or signs of distress associated with the particular disease. The data may be results of a patient questionnaire.

In accordance with one or more embodiments, determining one or more patient care services may include selecting a strategy of predetermined patient care services from a group of one or more strategies of predetermined patient care services associated with the patient based on the score. “Strategies of predetermined patient care services” can include a type of care including comprehensive care for that cycle of treatment at an affixed cost. “Strategies of predetermined patient care services” also can include a therapeutic strategy, treatment intent or both, wherein the treatment is curative, slow to progression, palliative, or hospice, and includes aggressiveness of care and aggressiveness of treatment.

In accordance with one or more embodiments, the patient may be associated with one or more treatment strategies of predetermined patient care services by classifying the patient into a nodal address (i.e., a CNA) based on the data comprising personal health information of the patient, where the nodal address represents a set of clinically relevant variables. In one example, the set of variables is matched with attributes of the patient in the data to classify the patient into the nodal address. The nodal address may be associated with the one or more strategies of predetermined patient care services. The nodal address may be represented as a discrete punctuated string of digits comprising a prefix, a middle, and a suffix that represent the set of variables. In one embodiment, each of the one or more strategies of predetermined patient care services is associated with a predetermined cost.

In accordance with one or more embodiments, the data comprising personal health information of the patient is analyzed by associating answers of each question, evaluating one or more symptoms of a disease, in a patient questionnaire with a grade value and associating ratings representing how the symptom impacts the patient's life with a grade value. For each question, the grade values of the selected answer is combined (e.g., multiplied) with the grade value of the selected rating to determine a initial scores. The initial scores for each question may be combined (e.g., by addition) to determine a final, cumulative distress score of the questionnaire. The cumulative distress score may be used to initiate and/or recommend and/or treat a patient with a preselected palliative care strategy based on one or more threshold grade values.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a high-level diagram of a communications system, in accordance with one embodiment;

FIG. 2 shows a system architecture for the analysis and evaluation of a patient to determine a clinical course of action for treating the patient, in accordance with one embodiment;

FIG. 3 shows an exemplary patient questionnaire, in accordance with one embodiment;

FIG. 4 shows a system architecture of a clinical outcome tracking and analysis module interacting with a patient care analysis system, in accordance with one embodiment;

FIG. 5 illustratively depicts a flow diagram of a method for selecting patient care services, in accordance with one embodiment; and

FIG. 6 shows a high-level block diagram of a computer, in accordance with one embodiment.

### DETAILED DESCRIPTION

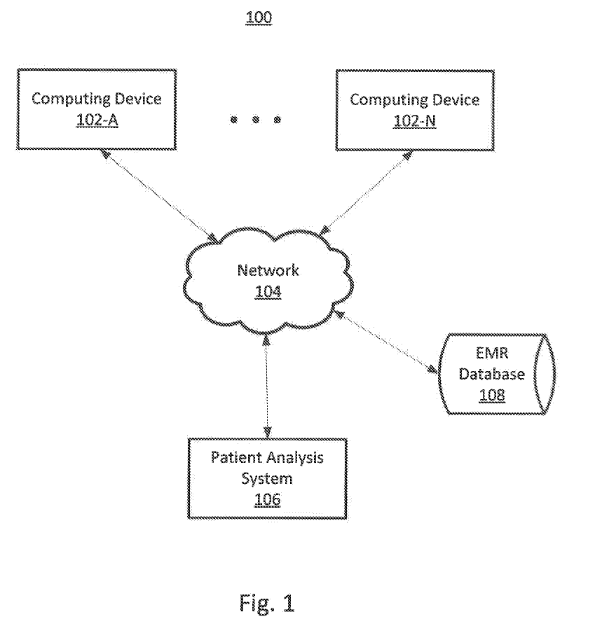

FIG. 1 shows a high-level diagram of a communications system 100, in accordance with one or more embodiments. Communications system 100 includes one or more computing devices 102-A, . . . , 102-N (collectively referred to as computing devices 102). Computing devices 102 may comprise any type of computing device, such as, e.g., a computer, a workstation, a server, a database, a tablet, or a mobile device. Computing devices 102 are operated by end users for communicating with each other via network 104. Network 104 may include any type of network or combination of different types of networks, and may be implemented using any suitable network technology in a wired and/or a wireless configuration. For example, network 104 may include one or more of the Internet, an intranet, a personal area network (PAN), a local area network (LAN), a wide area network (WAN), a metropolitan area network (MAN), a virtual private network (VPN), etc.

End users of computing devices 102 may communicate via network 104 for interacting with a patient analysis system 106 for determining a clinical course of action for treating a patient. In one particularly useful embodiment, patient analysis system 206 analyzes and evaluates the patient to determine a clinical course of action for a palliative care treatment plan for the patient to optimize quality of life and outcome. While patient analysis system 106 is described herein for the analysis of a patient, it should be understood that patient analysis system 106 may be employed for any medical or non-medical related analysis of any subject.

In some embodiments, communications system 100 may also include an electronic medical record (EMR) database 108 for storing patient data. End users of computing devices 102 and patient analysis system 106 may interact with EMR database 108 via network 104 for retrieving, storing, and/or manipulating patient data. The patient data stored in EMR database 108 may include any information that was obtained, used, or disclosed in the course of receiving medical care services, such as, e.g., diagnosis or treatment.

End users may interact with patient analysis system 106 and/or EMR database 108 via an interface of a web browser executing on computing device 102, an application executing on computing device 102, an app executing on computing device 102, or any other suitable interface for interacting with patient analysis system 106.

Advantageously, embodiments of the present invention provide for patient analysis system 106, which is configured to analyze a patient to determine a clinical course of action for treating the patient. In one embodiment, patient analysis system 106 determines a clinical course of action comprising palliative care treatment for the patient. Patient analysis system 106 in accordance with embodiments of the invention thus provides for improvements in computer related technology by facilitating objective, quantitative, and standardized decision-making for determining a clinical course of action for treating a patient. The present invention also provides for objective, quantitative and standardized methods for comparing healthcare provider responses to patient distress (e.g., benchmarking quality of care at the end of life) and/or for identifying variances in palliative care initiation and/or treatment among healthcare providers.

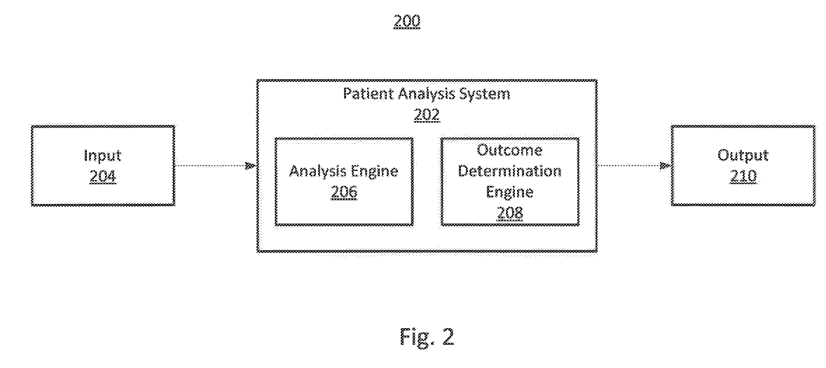

FIG. 2 shows a system architecture 200 for the analysis and evaluation of a patient to determine a clinical course of action for treating the patient, in accordance with one or more embodiments. System architecture 200 includes patient analysis system 202. In one embodiment, patient analysis system 202 is patient analysis system 106 of FIG. 1.

Patient analysis system 202 includes analysis engine 206. Analysis engine 206 is configured to provide patient analysis from input 204. In one embodiment, input 204 may be received from a user. For example, input 204 may be received from an end user of computing device 102 via network 104 in FIG. 1. The user may include. Input 204 may be received directly from the patient or may be received from another entity with knowledge of the patient's level of distress (e.g., a family member or caregiver, a doctor or other healthcare professional, a payer of medical services (e.g., an insurance provider or a representative of the insurance provider), or any other entity.

In another embodiment, input 204 may be previously stored data received from or retrieved from an external database. For example, input 204 may be received from or retrieved from an EMR database 108 via network 104 in FIG. 1. In one example, EMR database 108 may analyze data stored therein to identify relevant patient data and transmit the relevant patient data to patient analysis system 202 as input 204. In another example, patient analysis system 202 (e.g., analysis engine 206 of patient analysis system 202) may interact with EMR database 108 to identify the relevant patient data and retrieve the relevant patient data as input 204. The relevant patient data may be identified from EMR database 108 using any suitable method. In one embodiment, the relevant patient data may be identified (e.g., by EMR database 108 or analysis module 206) using methods known in the art.

Input 204 may include any data containing personal health information for analyzing a level of distress of the patient. The data received as input 204 may be in any suitable format. In one embodiment, the data is structured data in, e.g., XML (extensible markup language) format. In another embodiment, the data is unstructured data, which is structured by extracting relevant data using, e.g., methods known in the art. For example, the unstructured data may be, e.g., paragraphs of text, handwritten notes or drawings in a patient chart, etc.

In one embodiment, input 204 may include data relating to the level of distress of the patient, such as, e.g., data covering the domains of performance status, pain or other disease-related affliction, perception of being a burden to loved ones, perception of burdens related to financial costs of healthcare, and anxiety or depression of the patient. For example, input 204 may include results of a patient questionnaire. The patient questionnaire may be a disease-specific patient questionnaire. For example, the patient questionnaire may be directed to a specific progressive disease such as, e.g., a cancer, a pulmonary disease, a cardiac disease, a neurologic disorder, or any other progressive disease.

In one embodiment, input 204 may also include objective signs or symptoms of a disease (e.g., quantifiable hours spent in bed via nursing home records or medication records documenting pain medication usage) or assessments by medical professionals as to the levels of distress (such as, e.g., psychiatry input regarding diagnosis of depression).

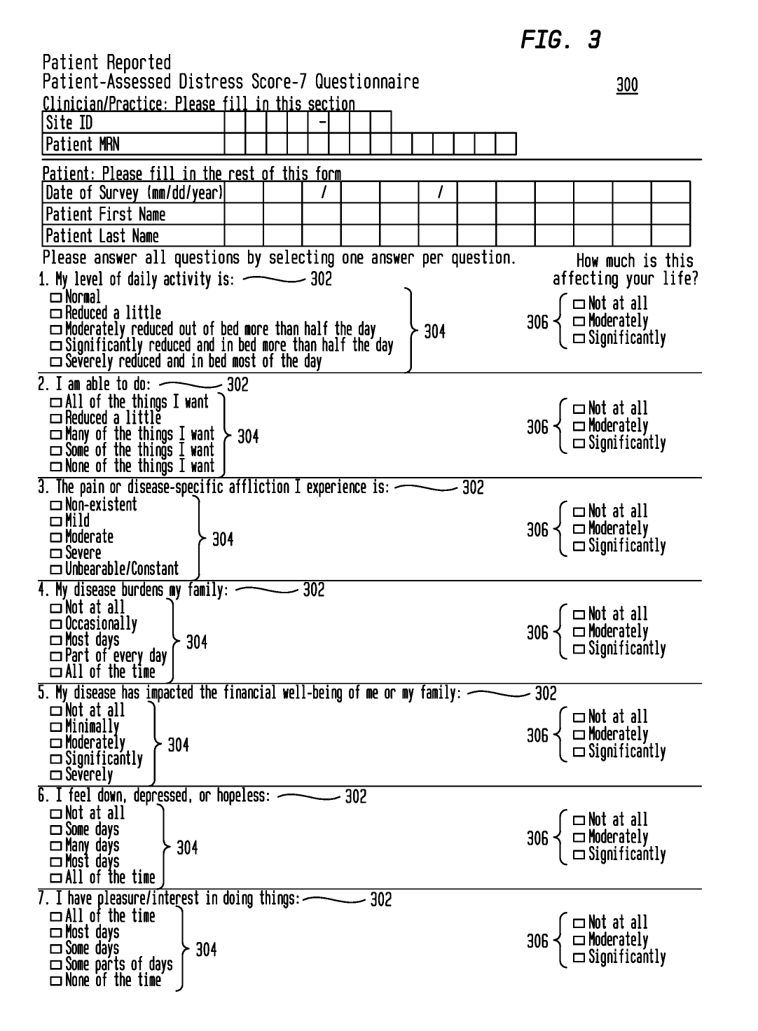

FIG. 3 shows an exemplary patient questionnaire 300, in accordance with one embodiment. Patient questionnaire 300 is specific to cancer and includes questions 302 to evaluate a level of distress of the patient. For example, patient questionnaire 300 includes questions 302 to evaluate a level of distress of the patient by evaluating symptoms of cancer, such as, e.g., the performance status, pain or other disease-related affliction, perception of being a burden to loved ones, perception of being a financial burden, and depression of the patient. Patient questionnaire 300 is shown having seven questions 302, but may include any number of questions suitable for evaluating symptoms of cancer. A user selects (e.g., using computing device 102 of FIG. 1) one or more of a plurality of answers 304 for each question 302 that most accurately describes the symptom associated with the question 302. The user also selects a rating 306 for each question 302, rating the severity of the symptom. In one example, the rating 306 of the symptom represents how much the symptom impacts the patient's life. In the exemplary embodiment shown in FIG. 3, the user selects rating 306 from one of the following answers: not at all, moderately, and significantly. Other forms of rating symptoms may also be employed.

Patient questionnaire 300 may be completed by any user with knowledge of the patient. For example, patient questionnaire 300 may be completed by the patient, a person associated with the patient (e.g., a family member or friend), a doctor or other healthcare professional, a payer of medical services (e.g., an insurance provider or a representative of the insurance provider), or any other suitable entity. Results of patient questionnaire 300 may be received by patient analysis system 202 as input 204 in FIG. 2.

While patient questionnaire 300 is shown as a cancer-specific patient questionnaire, it should be understood that similar patient questionnaires may be provided for any disease or any type of disease. For example, questions 302 and/or answers 304 in patient questionnaire 300 may be modified to evaluate symptoms specifically related to any progressive disease. For example, patient questionnaire 300 may be modified to evaluate a patient diagnosed with a progressive pulmonary disease may replacing one or more questions 302 and/or answer 304 (e.g., to include a question to evaluate shortness of breath).

Analysis engine 206 of patient analysis system 202 in FIG. 2 is configured to analyze input 204. In one embodiment, analysis engine 206 analyzes input 204 by determining a score for input 204. The score may represent the level of distress of the patient (combining multiple attributes, e.g., the performance status of the patient, meaning an evaluation of the patient's behavior by comparing it with preset standards, pain or other disease-related affliction, perception of being a burden to loved ones, perception of being a financial burden, and anxiety and/or depression of the patient). Any suitable scoring algorithm may be employed such as, e.g., those known in the art.

In one example, analysis engine 206 may analyze results of a patient questionnaire (e.g., patient questionnaire 300 of FIG. 3) by associating each answer 304 and each rating 306 with a grade value (e.g., point value). An initial score for each respective question 302 is determined by combining the grade value of the selected answer 304 with the grade value of the selected rating 306 (e.g., by multiplying the grade value of the selected answer 304 with the grade value of the selected rating 306). A score of patient questionnaire 300 is determined by combining the initial scores for each respective question 302 (e.g., by adding the scores for each respective question 302). Other approaches for scoring patient questionnaire 300 may also be employed.

Outcome determination engine 208 in patient analysis system 202 is configured to determine a clinical course of action for treating the patient based on the score determined by analysis engine 206. In one embodiment, a determination of one or more of whether or not to initiate treatment, aggressiveness of treatment, and aggressiveness of care of the patient is performed based on the score. For example, as the score satisfies (e.g., meets or exceeds) a predefined threshold value, a therapeutic strategy, therapeutic intent or both that is curative, effective to slow to progression or palliative care treatment may be suggested or required.

In another embodiment, different clinical courses of action may be associated with different threshold values (or different ranges of values). In this manner, a clinical course of action for treating a patient is determined as the clinical course of action associated with the respective threshold value or range of values that the final score satisfies. In one embodiment, the different clinical courses of action associated with different value or different ranges of values may range in increasing severity as the values increase or decrease. For example, the clinical courses of action may range in severity from no treatment to do not resuscitate.

The clinical course of action determined by outcome determination engine 208 is returned by patient analysis system 202 as output 210 for treatment of the patient. In one embodiment, patient analysis system 202 repeatedly analyzes input 204 to monitor the patient over time and modify or alter the clinical course of action accordingly. For example, patient analysis system 202 may analyze input 204 over periodic time intervals (e.g., daily, weekly, monthly, annually), following medical events (e.g., following every doctor checkup, following significant medical symptoms), etc. to determine updated scores; based on the updated scores, a new clinical course of action may be determined for treatment of the patient.

In one embodiment, patient analysis system 202 determines a clinical course of action for providing palliative care treatment for the patient as output 210. In this manner, patient analysis system 202 facilitates standardized, objective, and quantitative decision making for determining palliative care treatment for a patient, to thereby optimize quality of life and outcome of the patient.

In one embodiment, the score determined by patient analysis system 202 may be used to develop and/or assess quality benchmarks among healthcare providers. For example the treatment strategy patterns of physicians caring for patients with a certain total distress score may be compared against the treatment strategy patterns of different physicians caring for patients with similar distress scores. In one example, rates of chemotherapy administration and/or hospice referral and/or formal palliative care consultations may be compared among physicians treating patients with similar total distress scores. In this manner, patient analysis system facilitates standardized, objective, and quantitative measures of quality of care among patients with serious illness with regard to palliative care issues.

In one embodiment, the score determined by patient analysis system 202 may be used by healthcare providers and/or insurance industry and/or other entities to assess the adequacy of access to patient care services (e.g., palliative care services) and/or treatment for a defined population. For example, a hospital may note that a significant proportion of their patients exceed predefined distress score thresholds prompting expansion of palliative care services and/or hiring of additional healthcare personnel. For example an insurance carrier may note that a proportion of covered beneficiaries exceed predefined distress scores prompting expansion of palliative care programs and/or targeting of specific beneficiaries for access programs to existing programs.

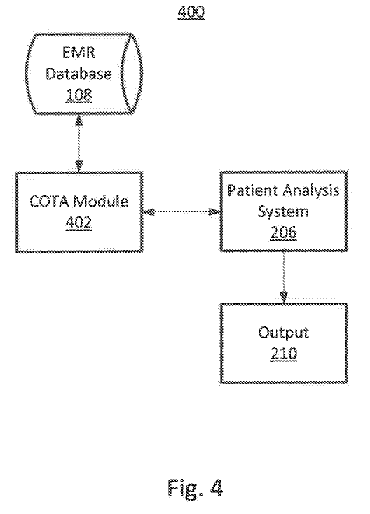

FIG. 4 illustratively depicts a system architecture 400 of a clinical outcome tracking and analysis (COTA) system or module 402 interacting with patient analysis system 206 of FIG. 2 for selecting predetermined strategies of patient care services for treatment of a patient, in accordance with one or more embodiments. COTA module 402 may interact with patient analysis system 206 via, e.g., network 104 of FIG. 1. While COTA module 402 and patient analysis system 206 are shown as separate components in system architecture 400, it should be understood that COTA system 402 and patient analysis system 206 may be integrated as a single component or separated into any number of discrete component parts. COTA module 402 is further described in U.S. patent application Ser. No. 14/507,640, titled “Clinical Outcome Tracking and Analysis,” filed Oct. 6, 2014, the disclosure of which is herein incorporated by reference in its entirety.

COTA module 402 assigns patients to one or more COTA nodal addresses (CNAs). The CNA represents one or more preselected variables (e.g., by an expert) that can be used to classify groups of patients (or data) into clinically relevant sets. For example, patients are assigned a CNA that represents variables that match the attributes of that patient. The attributes of the patient may be determined from EMR database 108. The variables may include, e.g., diagnoses, demographics, outcomes, phenotypes, or any other variable that can classify groups of patients into clinically relevant sets. The CNA may be represented in any suitable format to indicate its one or more preselected variables.

In one embodiment, the CNA is a list of variables (as a function of a letter representing the variable and a number representing the selection within the variable). For example, the letter A may represent the sex or gender variable and numbers 1 and 2 represent female and male patient, the letter B may represent the race variable and number 1 through 4 represent different races, etc. Thus, a CNA may be represented as A1-2, B1-4, . . . , N1.

In another embodiment, the CNA is represented as a plurality of discrete strings of digits separated by periods, where each string of digits indicates one or more variables (e.g., disease, phenotype, therapy type, progression/track, sex, etc.). For example, a first string of digits may represent a particular disease, a second string of digits may represent a type of disease, a third string of digits may indicate a subtype of the disease, and a further string of digits may indicate a phenotype. Thus, in this example, the first string of digits may be 01 indicating cancer, the second string of digits may be 02 indicating breast oncology, a third string of digits may be 01 indicating breast cancer, and a fourth string of digits may be 1201 representing particular characteristics of a phenotype such that the nodal address is 01.02.01.1201. It should be understood that the nodal address may include any number of strings of digits and is not limited to four strings.

Each CNA may be associated with one or more strategies of predetermined patient care services (e.g., clinical courses of action for treating a patient). In one embodiment, the strategies of predetermined patient care services define a treatment strategy, treatment intent, aggressiveness of care, or aggressiveness of treatment. In another embodiment, the strategies of predetermined patient care services represent a bundle of medical services for comprehensive care of the patient for a particular treatment cycle for a predetermined financial cost. Each strategy may comprise one or more patient care services determined by, e.g., one or more medical professionals, a hospital, a group, an insurance company, etc. to optimize patient care and/or cost. In one example, a strategy may indicate a number of imaging scans, a drug or choice of drugs, a schedule of when to administer the drugs, an operation or procedure, a number and frequency of follow up visits, etc. The bundling of patient care services may be particularly useful for risk contracting. For example, each strategy corresponding to a nodal address (associated with a particular disease) may have a predetermined cost allowing a user (e.g., doctor, patient, etc.) to choose an appropriate strategy. The cost may be determined or negotiated based on historical data associated with that particular disease or nodal address. Advantageously, the bundling of services provides cost certainty to an insurance company and/or hospital for a particular disease. This also reduces the cost of processing and maintaining records. Additionally, medical professionals will know ahead of time the predetermined course of treatment, which provides incentives to physicians to obtain better outcomes at lower costs.

Each nodal address reduces trillions of possible permutations to a reduced number of clinically meaningful permutations based on, e.g., the discrete punctuated string of digits representing each nodal address. According to some embodiments, this enables analysis of first behavioral and then consequent clinical and cost outcome variance from an ideal value, expressed as best clinical outcome at lowest possible cost, in a requisite time needed to alert for necessary care and avoidance of unnecessary care, thereby increasing the value of care, meaning better clinical outcomes at a lowest possible cost. According to some embodiments, the CNA enables identification of a specific patient as a candidate for a specific treatment, clinical trial, or drug. According to some embodiments, the CNA provides an analytic interface with connections to claims data to support health plans, hospitals and physician practices in managing doctors and other health care providers. According to some embodiments, CNAs reduce processing requirements and time for processing to make real-time monitoring efficient based on the discrete punctuated string of digits representing each nodal address and based on the reduction in permutations. This real time monitoring enables prediction of key points in time at which, for example, behavioral variance is likely to occur and interrupts treatment flow to avoid over-/under-utilization of care to prevent the behavioral variance.

According to some embodiments, patient analysis system 206 analyzes the patient to select one of the one or more strategies associated with the CNA assigned to the patient as output 210. For example, analysis engine 206 (FIG. 2) of patient analysis system 202 may analyze results of patient questionnaire 300 of FIG. 3 by determining a score to evaluate the patient for initiating or recommending palliative care. Exemplary criteria can include, e.g., the performance status of the patient, pain, perception of being a burden to loved ones, perception of being a financial burden, and mental state (e.g., anxiety, depression) of the patient for recommending, and/or initiating palliative care treatment of the patient. Based on the score, outcome determination engine 208 (FIG. 2) of patient analysis system 202 selects one of the predetermined strategies associated with the CNA assigned to the patient for palliative care treatment. For example, each of the predetermined strategies may be associated with a threshold value (or a range of score values). Each of the predetermined strategies may represent different levels of palliative care treatment (e.g., ranging from full disease modifying or life-prolonging treatment without palliative care treatment, to full palliative care without disease modifying or life-prolonging treatment, to hospice). The predetermined strategies associated with threshold value that is satisfied by the score is selected so as to provide the appropriate level of palliative treatment of the patient. In one embodiment, patient analysis system 202 may continuously (e.g., at periodic intervals, following medical events, etc.) analyze the patient and as the score changes, other predetermined strategies may be selected to adjust or modify the treatment. As such, palliative care treatment may be continually altered to follow the clinical course of the underlying disease being treated.

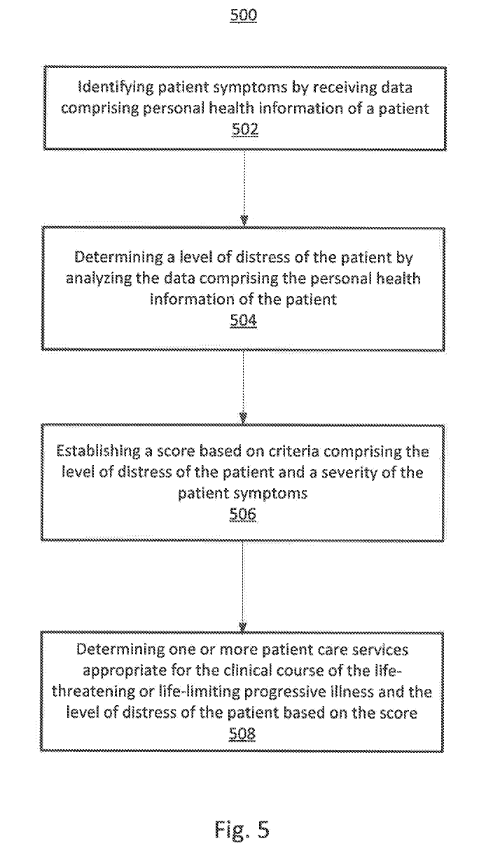

FIG. 5 shows a flow diagram of a method 500 of operation of the patient analysis system 202, in accordance with one or more embodiments.

At step 502, patient symptoms are identified by receiving data comprising personal health information of the patent. The data may be received from a user (e.g., using computing device 102 of FIG. 1) or from an external database (e.g., EMR database 108 of FIG. 1). The data may be data representing the level of distress of the patient, such as, e.g., data covering the domains of performance status, pain or disease-related affliction, perception of being a burden to loved ones, perception of being a financial burden, and anxiety and/or depression of the patient. In one embodiment, the data may be results of a patient questionnaire (e.g., patient questionnaire 300 of FIG. 3).

At step 504, a level of distress of the patient is determined by analyzing the data comprising personal health information of the patent. In one embodiment, the level of distress of the patient is determined based on answers 304 of patient questionnaire 300 selected by a user to evaluate one or more symptoms specific to the current state of the patient's progressive disease.

At step 506, a score is established based on one or more criteria. For example, the criteria may include the level of distress of the patient and a severity of the patient symptoms. In one embodiment, the level of distress is determined at step 504 and the severity of the patient symptoms is determined based on ratings 306 selected by a user in patient questionnaire 300 to evaluate a severity of one or more symptoms specific to the current state of the patient's progressive disease. In one embodiment, the score is established by associating the level of distress (i.e., each selected answer 304) and each severity of the patient symptoms (i.e., rating 306) with a grade value and combining (e.g., multiplying) the grade values of the selected answer and selected rating to determine a score for each question. The scores for each question are combined (e.g., added) to determine a final score of patient questionnaire 300.

At step 508, one or more patient care services appropriate for the clinical course of the life-threatening or life-limiting progressive illness and the level of distress of the patient are selected based on the score. The one or more patient care services may be determined based on one or more thresholds.

In one embodiment, the one or more patient care services are determined by selecting a strategy of predetermined patient care services from a group of one or more strategies of predetermined patient care services associated with the patient based on a fixed cost, or a therapeutic strategy, treatment intent or both based on aggressiveness of care and aggressiveness of treatment based on the score. The therapeutic strategy may comprise a curative treatment, a slow to progression treatment, or a palliative treatment. In one embodiment, the patient is associated with one or more strategies of predetermined patient care services by classifying the patient into a nodal address (i.e., a CNA) based on the data comprising personal health information of the patent, where the nodal address represents a set of variables. In one example, the set of variables is matched with attributes of the patient in the data to classify the patient into the nodal address. The nodal address is associated with the one or more strategies of predetermined patient care services. The nodal address may be represented as a discrete punctuated string of digits comprising a prefix, a middle, and a suffix that represent the set of variables. In one embodiment, each of the one or more strategies of predetermined patient care services is associated with a predetermined cost.

In one embodiment, updated data comprising personal health information of the patent may be received and steps 502 through 508 may be repeated for that updated data to determine an updated score and determine another one of the one or more patient care services based on the updated score.

Systems, apparatuses, and methods described herein may be implemented in paper form. For example, input 204 of FIG. 2 may comprise handwritten notes and drawings on a patient chart. The patient chart may be analyzed on paper to determine output 210 of one or more patient care services.

Additionally or alternatively, systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 5. Certain steps of the methods described herein, including one or more of the steps of FIG. 5, may be performed by a server or by another processor in a network-based cloud-computing system. Certain steps of the methods described herein, including one or more of the steps of FIG. 5, may be performed by a client computer in a network-based cloud computing system. The steps of the methods described herein, including one or more of the steps of FIG. 5, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

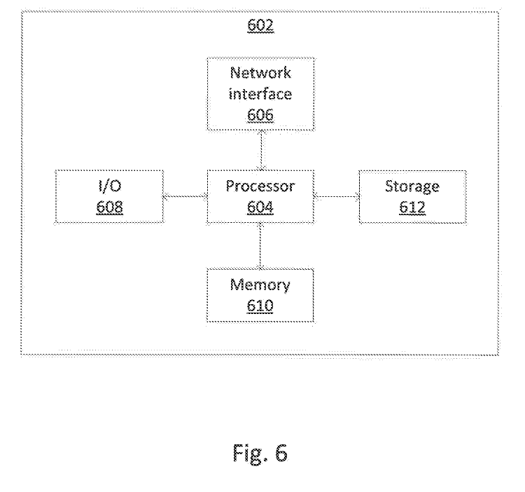

A high-level block diagram 600 of an example computer that may be used to implement systems, apparatus, and methods described herein is depicted in FIG. 6. Computer 602 includes a processor 604 operatively coupled to a data storage device 612 and a memory 610. Processor 604 controls the overall operation of computer 602 by executing computer program instructions that define such operations. The computer program instructions may be stored in data storage device 612, or other computer readable medium, and loaded into memory 610 when execution of the computer program instructions is desired. Thus, the method steps of FIG. 5 can be defined by the computer program instructions stored in memory 610 and/or data storage device 612 and controlled by processor 604 executing the computer program instructions. For example, the computer program instructions can be implemented as computer executable code programmed by one skilled in the art to perform the method steps of FIG. 5. Accordingly, by executing the computer program instructions, the processor 604 executes the method steps of FIG. 5. Computer 602 may also include one or more network interfaces 606 for communicating with other devices via a network. Computer 602 may also include one or more input/output devices 608 that enable user interaction with computer 602 (e.g., display, keyboard, mouse, speakers, buttons, etc.).

Processor 604 may include both general and special purpose microprocessors, and may be the sole processor or one of multiple processors of computer 602. Processor 604 may include one or more central processing units (CPUs), for example. Processor 604, data storage device 612, and/or memory 610 may include, be supplemented by, or incorporated in, one or more application-specific integrated circuits (ASICs) and/or one or more field programmable gate arrays (FPGAs).

Data storage device 612 and memory 610 each include a tangible non-transitory computer readable storage medium. Data storage device 612, and memory 610, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 608 may include peripherals, such as a printer, scanner, display screen, etc. For example, input/output devices 608 may include a display device such as a cathode ray tube (CRT) or liquid crystal display (LCD) monitor for displaying information to the user, a keyboard, and a pointing device such as a mouse or a trackball by which the user can provide input to computer 602.

Any or all of the systems and apparatus discussed herein, including computing devices 102, patient analysis system 106, and EMR database 108 of FIG. 1, components of patient analysis system 202 of FIG. 2, and COTA module 402 of FIG. 4 may be implemented using one or more computers such as computer 602.

One skilled in the art will recognize that an implementation of an actual computer or computer system may have other structures and may contain other components as well, and that FIG. 6 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the described invention and that various modifications may be implemented by those skilled in the art without departing from the scope and spirit of the invention. Those skilled in the art could implement various other feature combinations without departing from the scope and spirit of the invention.

1. A method for evaluating patient care services for one or more patients being treated for a life-threatening or life-limiting progressive illness, the method comprising:
(a) by receiving, by a system comprising a processor, data comprising personal health information of a plurality of patients being treated for a life-threatening or life-limiting progressive illness, the data for each patient including information regarding a severity of symptoms of the patient and information relating to a level of distress of the patient;
(b) for each patient in the plurality, determining a level of distress of the patient and a severity of symptoms of the patient by analyzing, by the system, the data comprising the personal health information of the patient;
(c) establishing, by the system, a distress score for each patient in the plurality based on criteria comprising the level of distress of the patient and a severity of the patient symptoms;
(d) classifying each patient into a nodal address based on the data comprising personal health information, the nodal address representing a set of clinically relevant variables matched to attributes of the patient in the data;
(e) comparing distress scores of a first group of one or more patients classified in a nodal address with distress scores of a second group of one or more patients classified in the same nodal address to evaluate the adequacy of patient care services for the first group of one or more patients being treated for a life-threatening or life-limiting progressive illness; and
(f) where the comparison of distress scores of the first group of patients with the distress scores of the second group of patients indicates that distress is not adequately addressed for patients in the first group of patients, generating a notification for a heath care provider or insurance provider for at least one patient in the first group of patients that distress is not adequately addressed for the at least one patient.

2. The method of claim 1, wherein the first group of one or more patients are being treated by a first entity and the second group of one or more patients are being treated by one or more entities other than the first entity.

3. The method of claim 37, further comprising determining one or more patient care services for each of the one or more patients in the first group by selecting a strategy of predetermined patient care services for each patent from the group of one or more strategies of predetermined patient care services associated with the nodal address of the patient based on the distress score for the patient thereby determining
an aggressiveness of care and aggressiveness of treatment for each patient based on the distress score for the patient.

4. The method of claim 3, wherein selecting a strategy of predetermined patient care services comprises:
selecting the strategy of predetermined patient care services from the group of one or more strategies of predetermined patient care services based on one or more thresholds for the distress score.

5.-6. (canceled)

7. The method of claim 1, further comprising:
representing the nodal address as a discrete punctuated string of digits comprising a prefix, a middle, and a suffix that represent the set of clinically relevant variables.

8.-9. (canceled)

10. The method of claim 1, wherein the information relating to a level of distress of the patient comprises results of a patient questionnaire effective to establish a level of distress of the patient.

11. The method of claim 1, wherein the data for each patient including information regarding the severity of symptoms of the patient and information relating to the level of distress of the patient includes information regarding at least one of performance status, pain, perception of being a burden to loved ones, perception of financial burden, and depression of the patient.

12. The method of claim 1, further comprising:
receiving updated data comprising updated personal health information of one or more of the plurality of patients;
analyzing the updated data comprising the updated personal health information of the one or more patients to determine an updated distress score based on criteria comprising the level of distress of the patient and the severity of the patient symptoms;
determining if the nodal address of each of the one or more patients with updated personal health information requires updating based on the updated data and updating the nodal address of the patient if required; and
comparing distress scores of the first group of one or more patients classified in a nodal address with distress scores of a second group of one or more patients classified in the same nodal address to evaluate the adequacy of patient care services for the first group of one or more patients, wherein the first group of one or more patients includes at least one of the one or more patients having updated personal health information.

13. A non-transitory computer readable storage medium storing computer program instructions for evaluating patient care services for one or more patients being treated for a life-threatening or life-limiting progressive illness, the instructions, when executed on a processor, cause the processor to perform operations comprising:
(a) receiving data comprising personal health information of a plurality of patients being treated for a life-threatening or life-limiting progressive illness, the data for each patient including information regarding a severity of symptoms of the patient and information relating to a level of distress of the patient;
(b) for each patient in the plurality, determining a level of distress of the patient and a severity of symptoms of the patient by analyzing the data comprising the personal health information of the patient;
(c) establishing a distress score for each patient in the plurality based on criteria comprising the level of distress of the patient and a severity of the patient symptoms;
(d) classifying each patient into a nodal address based on the data comprising personal health information, the nodal address representing a set of clinically relevant variables matched to attributes of the patient in the data;
(e) comparing distress scores of a first group of one or more patients classified in a nodal address with distress scores of a second group of one or more patients classified in the same nodal address to evaluate the adequacy of patient care services for the first group of one or more patients being treated for a life-threatening or life-limiting progressive illness; and
(f) where the comparison of distress scores of the first group of patients with the distress scores of the second group of patients indicates that distress is not adequately addressed for patients in the first group of patients, generating a notification for a heath care provider or insurance provider for at least one patient in the first group of patients that distress is not adequately addressed for the at least one patient.

14. The non-transitory computer readable storage medium of claim 13, wherein the first group of one or more patients are being treated by a first entity and the second group of one or more patients are being treated by one or more entities other than the first entity.

15. The non-transitory computer readable storage medium of claim 38, further comprising determining one or more patient care services for each of the one or more patients in the first group by selecting a strategy of predetermined patient care services for each patent from the group of one or more strategies of predetermined patient care services associated with the nodal address of the patient based on the distress score thereby determining
an aggressiveness of care and aggressiveness of treatment for each patient based on the distress score for the patient.

16. The non-transitory computer readable storage medium of claim 15, wherein selecting a strategy of predetermined patient care services comprises:
selecting the strategy of predetermined patient care services from the group of one or more strategies of predetermined patient care services based on one or more thresholds for the distress score.

17.-18. (canceled)

19. The non-transitory computer readable storage medium of claim 1, the operations further comprising:
representing the nodal address as a discrete punctuated string of digits comprising a prefix, a middle, and a suffix that represent the set of variables.

20.-21. (canceled)

22. The non-transitory computer readable storage medium of claim 13, wherein, for each patient, the information relating to a level of distress of the patient comprises results of a patient questionnaire effective to establish a level of distress of the patient.

23. The non-transitory computer readable storage medium of claim 13, wherein the data for each patient including information regarding the severity of symptoms of the patient and information relating to the level of distress of the patient includes information regarding at least one of performance status, pain, perception of being a burden to loved ones, perception of financial burden, and depression of the patient.

24. The non-transitory computer readable storage medium of claim 13, the operations further comprising:
receiving updated data comprising updated personal health information of one or more of the plurality of patients;
analyzing the updated data comprising the updated personal health information of the one or more patients to determine an updated score based on criteria comprising the level of distress of the patient and the severity of the patient symptoms;
determining if the nodal address of each of the one or more patients with updated personal health information requires updating based on the updated data and updating the nodal address of the patient if required; and
comparing distress scores of the first group of one or more patients classified in a nodal address with distress scores of a second group of one or more patients classified in the same nodal address to evaluate the adequacy of patient care services for the first group of one or more patients, wherein the first group of one or more patients includes at least one of the one or more patients having updated personal health information.

25. A system for evaluating patient care services for one or more patients being treated for a life-threatening or life-limiting progressive illness, the system comprising:
a database configured to store data comprising personal health information of a plurality of patients being treated for a life-threatening or life-limiting progressive illness; and
a patient analysis system comprising:
a processor; and
memory to store computer program instructions, the computer program instructions when executed on the processor cause the processor to perform operations comprising:
(a) receiving the data comprising the personal health information of a plurality of patients being treated for a life-threatening or life-limiting progressive illness, the data for each patient including information regarding a severity of symptoms of the patient and information relating to a level of distress of the patient;
(b) for each patient in the plurality, determining a level of distress of the patient and a severity of symptoms of the patient by analyzing the data comprising the personal health information of the patient;
(c) establishing a distress score for each patient in the plurality based on criteria comprising the level of distress of the patient and a severity of the patient symptoms;
(d) classifying each patient into a nodal address based on the data comprising personal health information, the nodal address representing a set of clinically relevant variables matched to attributes of the patient in the data;
(e) comparing distress scores of a first group of one or more patients classified in a nodal address with distress scores of a second group of one or more patients classified in the same nodal address to evaluate the adequacy of patient care services for the first group of one or more patients being treated for a life-threatening or life-limiting progressive illness; and
(f) where the comparison of distress scores of the first group of patients with the distress scores of the second group of patients indicates that distress is not adequately addressed for patients in the first group of patients, generating a notification for a heath care provider or insurance provider for at least one patient in the first group of patients that distress is not adequately addressed for the at least one patient.

26. The system of claim 25, wherein the first group of one or more patients are being treated by a first entity and the second group of one or more patients are being treated by one or more entities other than the first entity.

27. The system of claim 39, further comprising determining one or more patient care services for each of the one or more patients in the first group by selecting a strategy of predetermined patient care services for each patient from the group of one or more strategies of predetermined patient care services associated with the nodal address of the patient based on the distress score thereby determining
an aggressiveness of care and aggressiveness of treatment for each patient based on the distress score for the patient.

28. The system of claim 27, wherein selecting a strategy of predetermined patient care services comprises:
selecting the strategy of predetermined patient care services from the group of one or more strategies of predetermined patient care services based on one or more thresholds for the distress score.

29.-30. (canceled)

31. The system of claim 25, the operations further comprising:
representing the nodal address as a discrete punctuated string of digits comprising a prefix, a middle, and a suffix that represent the set of variables.

32.-33. (canceled)

34. The system of claim 25, wherein, for each patient, the information relating to a level of distress of the patient comprises results of a patient questionnaire effective to establish a level of distress of the patient.

35. The system of claim 25, wherein the data for each patient including information regarding the severity of symptoms of the patient and information relating to the level of distress of the patient includes information regarding at least one of performance status, pain, perception of being a burden to loved ones, perception of financial burden, and depression of the patient.

36. The system of claim 25, the operations further comprising:
receiving updated data comprising updated personal health information of one or more of the plurality of patients;
analyzing the updated data comprising the updated personal health information of the one or more patients to determine an updated score based on criteria comprising the level of distress of the patient and the severity of the patient symptoms;
determining if the nodal address of each of the one or more patients with updated personal health information requires updating based on the updated data and updating the nodal address of the patient if required; and
comparing distress scores of the first group of one or more patients classified in a nodal address with distress scores of a second group of one or more patients classified in the same nodal address to evaluate the adequacy of patient care services for the first group of one or more patients, wherein the first group of one or more patients includes at least one of the one or more patients having updated personal health information.

37. The method of claim 1, wherein each nodal address is associated with a group of one or more strategies of predetermined patient care services, the group of one or more strategies of predetermined patient care services comprising: a therapeutic strategy including a slow to progression treatment or a palliative care treatment; a treatment intent including slow to progression or palliative; or both.

38. The non-transitory computer readable storage medium of claim 13, wherein each nodal address is associated with a group of one or more strategies of predetermined patient care services, the group of one or more strategies of predetermined patient care services comprising: a therapeutic strategy including a slow to progression treatment or a palliative care treatment; a treatment intent including slow to progression or palliative; or both.

39. The system of claim 25, wherein each nodal address is associated with a group of one or more strategies of predetermined patient care services, the group of one or more strategies of predetermined patient care services comprising: a therapeutic strategy including a slow to progression treatment or a palliative care treatment; a treatment intent including slow to progression or palliative; or both.
